(19) United States
(12) Patent Application Publication
(10) Pub. No.: US 2001/0011687 A1
(43) Pub. Date: Aug. 9, 2001

(54) Nozzle for an aerosol receptacle

(76) Inventor: Jean Francois Benoist, Lagny Sur Marne (FR)

Correspondence Address: Oliff & Berridge PLC, P. O. Box 19928, Alexandria, VA, 22320, US

(21) Appl. No.: 09/733,041

(22) Filed: Dec. 11, 2000

(30) Foreign Application Priority Data
Dec. 16, 1999 (FR) 99 15885

(51) Int. Cl. B05B 1/34

(52) U.S. Cl. 239/492; 239/491; 239/490; 239/472; 239/337; 239/333

(57) ABSTRACT

A swirling effect nozzle has substance feed channels opening out into a swirling chamber which communicates with an outlet orifice. The ratio Aₚ/Aₒ where Aₚ is the smallest total section offered by the channels to the passage of the substance and Aₒ is the section of the outlet orifice is less than or equal to 0.5.

The present invention relates to the field of aerosol receptacles.

### BACKGROUND OF THE INVENTION

It is known to dispense cosmetics, in particular hair sprays and deodorants, by using aerosol receptacles containing a liquefied propellant gas, e.g. a hydrocarbon.

In addition to acting as a propellant, the liquefied propellant gas also performs a second function for the content: it acts as a solvent, and as it leaves the nozzle it expands and encourages the droplets to break up.

The use of a liquefied propellant gas makes it possible to obtain a spray that is fine, that is almost transparent, that squirts quite hard, and that is capable of presenting sneeze-inducing properties.

There exists a need to obtain a spray that is more opaque, that drifts downwards, and that gives a more gentle impression.

Such a spray can be obtained by using a compressed propellant gas such as air, nitrogen, or a soluble compressed gas such as carbon dioxide.

### OBJECTS AND SUMMARY OF THE INVENTION

The invention seeks in particular to obtain an equivalent result by using a liquefied propellant gas.

The invention achieves this by a swirling effect nozzle having substance feed channels opening out into a swirling chamber communicating with an outlet orifice, wherein the ratio Aₚ/Aₒ is less than or equal to 0.5 and the ratio Aₚ/(Dₛ·dₒ) is less than or equal to 0.2; where: Aₚ is the smallest total section offered by the channels to the passage of the substance; Aₒ is the section of the outlet orifice; dₒ is the diameter of the outlet orifice; and Dₛ is the diameter of the swirling chamber.

The section Aₒ of the outlet orifice must be understood as being the smallest section through which the substance passes.

By means of the invention, it is possible to obtain a spray that is relatively opaque and that puffs relatively gently, thus enabling the droplets to come together and fall.

The Applicant has observed that a particularly satisfactory spray is obtained when the above conditions are fulfilled.

Preferably, the ratio Lₛ/Dₛ is less than or equal to 0.25; where: Lₛ is the length of the portion of the swirling chamber parallel to the axis of the nozzle and measured along the axis of the nozzle.

Advantageously, the nozzle has a plurality of channels, preferably two to six channels, and more preferably still four channels.

Advantageously, the ratio Aₚ/Aₒ is less than or equal to 0.4, advantageously less than or equal to 0.3, preferably lies in the range 0.15 to 0.35, and more preferably lies in the range 0.2 to 0.3.

Advantageously, the ratio Aₚ/(Dₛ·dₒ) is less than or equal to 0.15, preferably lies in the range 0.1 to 0.15, and more preferably lies in the range 0.11 to 0.14.

Advantageously, the ratio Lₛ/Dₛ is less than or equal to 0.2, is preferably less than or equal to 0.15, and more preferably lies in the range 0.1 to 0.15.

In a particular embodiment, the outlet orifice is circularly cylindrical and connects to the swirling chamber via a tapering chamber that converges towards the outlet.

In a particular embodiment, the diameter dₒ of the outlet orifice lies in the range 0.4 millimeters (mm) to 1.2 mm, Lₛ lies in the range 0.1 mm to 0.2 mm, and Dₛ lies in the range 0.6 mm to 1.4 mm, preferably in the range 0.8 mm to 1.2 mm, and more preferably is about 1 mm.

The invention also provides a dispenser head, including includes at least one nozzle as defined above.

In a particular embodiment, the nozzle is engaged on a center post.

The invention also provides an aerosol receptacle, including a nozzle as defined above.

In a particular embodiment, the receptacle contains a liquefied propellant gas.

In a variant, it contains a propellant gas constituted by a non-liquefied compressed gas, preferably compressed air, the nozzle of the invention enabling a spray to be obtained that presents good characteristics even with a non-liquefied propellant gas.

Still in a particular embodiment, the receptacle contains a cosmetic.

By way of example, the cosmetic can be a hair spray or a deodorant.

In a particular embodiment, the mean droplet size of the spray, when the receptacle is full and at 20° C., lies in the range 30 micrometers (μm) to 100 μm, preferably lies in the range 40 μm to 80 μm, and more preferably still is close to 60 μm.

Still in a particular embodiment, the flow rate of the spray, when the receptacle is full and at 20° C., lies in the range 0.3 grams per second (g/s) to 1.5 g/s, and preferably lies in the range 0.4 g/s to 1 g/s.

Still in a particular embodiment, the puff force of the spray, measured at 20° C. and when the receptacle is full, is less than or equal to 0.05 newtons (N), and is preferably close to 0.025 N.

The pressure inside the aerosol receptacle, when full and at 20° C., can lie in the range 2 bars to 6 bars, for example.

### BRIEF DESCRIPTION OF THE DRAWING

The invention will be better understood on reading the following detailed description of a non-limiting embodiment, and on examining the accompanying drawing, in which:

FIG. 1 is a diagrammatic axial section on section line I-I of FIG. 2, through a nozzle constituting an embodiment of the invention;

FIG. 2 is a front view seen along arrow II of FIG. 1;

FIG. 3 is a fragmentary diagrammatic perspective view of the nozzle; and

FIG. 4 is a fragmentary and diagrammatic axial section showing how the nozzle is mounted on a center post.

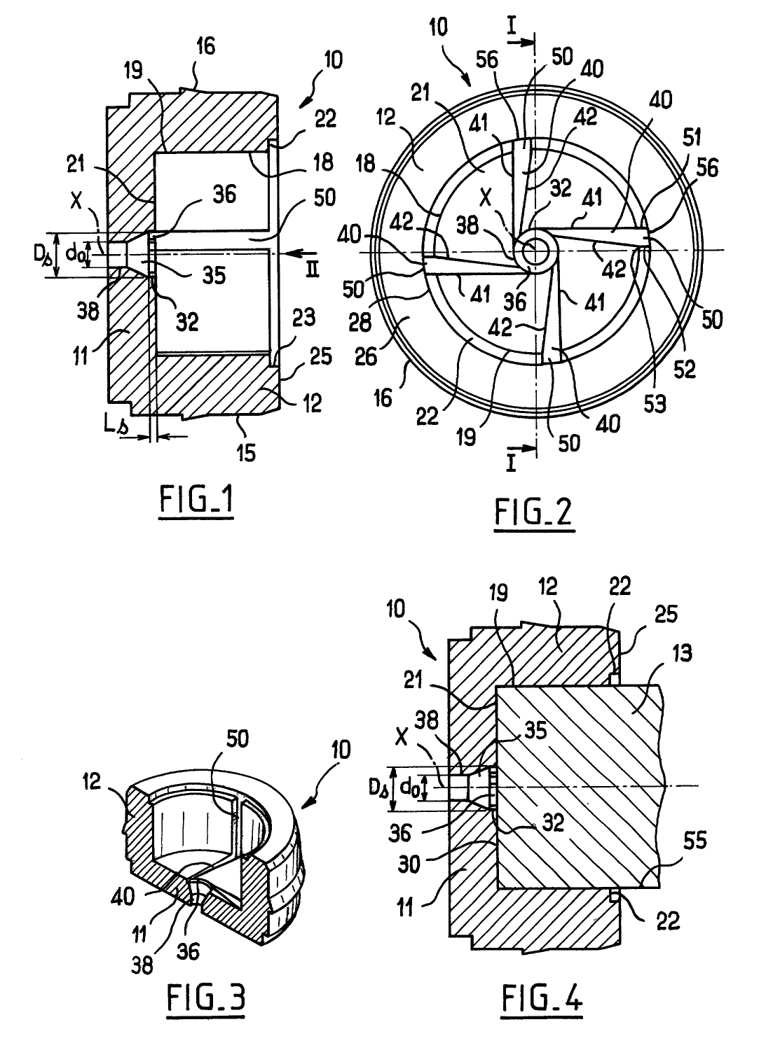

### MORE DETAILED DESCRIPTION

The figures show a nozzle 10 made as a single piece by molding a plastics material.

The nozzle 10 has a front wall 11 that is extended rearwards at its periphery by a skirt 12 that is tubular about an axis X.

The tubular skirt 12 is for mounting on a peg or center post 13 of a dispenser head shown in part in FIG. 4.

The center post 13 has a circularly cylindrical surface 55 about the axis X and a front face 30 which is plane and perpendicular to the axis X.

The radially outer surface 15 of the tubular skirt 12 is adapted to enable the nozzle to be mounted on the dispenser head and can have a variety of shapes.

In the embodiment shown, the surface 15 presents an annular portion in relief 16 for snap-fastening the nozzle 10 in a housing of suitable shape in the dispenser head.

The radially inner surface 18 of the skirt 12 is stepped and has a circularly cylindrical portion 19 about the axis X that extends axially between the rear face 21 of the front wall 11 and a shoulder 22.

The surface 18 also has a circularly cylindrical portion 23 about the axis X that is of larger diameter than the portion 19 and that extends between said shoulder 22 and the rear face 25 of the tubular skirt 12.

When the nozzle 10 is engaged on the center post 13, the rear face 21 of the front wall 11 comes to bear against the front face 30 of the center post 13.

The front wall 11 has an outlet orifice 38 that is circularly cylindrical about the axis X, of diameter dₒ, and of section Aₒ, that opens out forwards in the front face of the nozzle 10 and rearwards into a tapering chamber 35 that converges towards the outlet orifice 38.

The tapering chamber 35 opens out to a swirling chamber 36 defined radially by a surface 32 that is circularly cylindrical about the axis X, that is of diameter Dₛ, and that is of length Lₛ along the axis X.

Four channels 40 are formed in the rear face 21 of the front wall 11 to feed the mixture of propellant gas and substance to be sprayed to the swirling chamber 36.

The channels 40 open out tangentially into the swirling chamber 36, as shown in FIG. 2.

In the embodiment described, starting from a given channel 40, the other channels 40 are identical to said channel after rotation through 90°, 180°, or 270° respectively in the same direction about the axis X.

Each channel 40 is defined laterally, along the front wall 11, on one side by a plane surface 41 that is tangential to the cylindrical surface 32 and perpendicular both to the plane of the rear face 21 and to a diametral plane of the swirling chamber 36, and on the other side by a plane surface 42 that is perpendicular to the plane of the rear face 21 and that forms an angle relative to the surface 41 so that the width of each channel 40 tapers progressively from the intersection of the surface 42 with the portion 19 of the radially inner surface 18 of the skirt 12 towards the intersection of the surface 42 with the cylindrical surface 32 of the swirling chamber 36.

The planes containing the surfaces 41 and 42 intersect on a line that is parallel to the axis X.

The depth of each channel 40 is equal to the length Lₛ of the swirling chamber 36.

Four axial channels 50 are recessed in the cylindrical portion 19 to feed the channels 40 with substance.

The channels 50 extend along the full length of the cylindrical portion 19.

Each channel 50 is defined laterally, as can be seen in FIG. 2, on one side by a plane surface 51 coplanar with the surface 41, and on the other side by a surface 52 parallel to the surface 51 and meeting the surface 42 at an edge 53.

The channels 50 are defined radially, on the inside by the cylindrical surface 55 of the center post 13, and on the outside by a portion 56 of a circular cylinder having the same diameter as the cylindrical surface 23.

The channels 50 thus open out at the rear of the nozzle 10 between the center post 13 and the cylindrical surface 23.

The dispenser head on which the nozzle 10 is fixed is itself mounted on an aerosol receptacle containing a cosmetic and a propellant gas constituted in the present example by a liquefied gas.

The cosmetic in question can be constituted, for example, by a hair spray or by a deodorant.

According to the invention, the ratio Aₚ/Aₒ is less than or equal to 0.5, and the ratio Aₚ/(Dₛ·dₒ) is less than or equal to 0.2, where Aₚ is the smallest section provided by the sum of the channels 40 for passing the substance, and Aₒ is the section of the outlet orifice.

In the embodiment described, the section Aₚ is four times the smallest section offered to the flow of substance by any one channel 40.

In the embodiment described, the length Lₛ of the swirling chamber 36 is 0.13 mm, its diameter Dₛ is 1 mm, the diameter dₒ of the outlet orifice 38 is 0.6 mm, and the narrowest width of the channels is 0.13 mm, such that the ratio Aₚ/Aₒ is 0.2391.

The ratio Aₚ/(Dₛ·dₒ) is 0.1127 and the ratio Lₛ/Dₛ is 0.13.

Tests have shown that when the aerosol receptacle is full and contains 55% hair spray and 45% dimethyl ether at a pressure of 3.1 bars and at a temperature of 20° C., the nozzle enables a flow rate of about 0.5 g/s to be obtained with a mean droplet size of about 60 μm and a puff force of 0.025 N.

The resulting spray is particularly gentle, presenting an opaque, foggy appearance and falling in a manner similar to the sprays that are obtained by using compressed propellant gases, whether soluble or otherwise.

Other tests performed by the Applicant with nozzles having other dimensions, in particular different values for the diameter of the outlet orifice and for the width of the channels, confirm that an opaque and falling spray is obtained when Aₚ/Aₒ is less than or equal to 0.5.

The puff force corresponds to the thrust obtained at 20° C. when spraying at a rigid circular disk having a diameter of 150 mm, on the same axis as the nozzle, and situated at a distance of 150 mm from the dispenser head.

By way of example, the hair spray contained a film-generating polymer dissolved in a solvent.

A film-generating polymer stiffens the hair after the solvent has evaporated.

The solvent can be ethanol, for example.

The spray can contain 1% to 6% film-generating polymer.

Of film-generating polymers that are suitable for use, particular mention can be made of film-generating polymers prepared from the following substances, it being understood that this list is not limiting: polyvinyl-pyrrolidone; polystyrene sulfonate; polyethyl oxazoline; and copolymers of: vinyl acetate, crotonic acid, and vinyl t-butyl benzoate; vinylpyrrolidone and vinyl acetate; vinylpyrrolidone and acrylates; vinyl acetate and crotonic acid; vinyl acetate, crotonic acid, and vinyl neodecanoate; octylacylamide and acrylate; octylacrylamide, acrylate, and butylaminoethyl methacrylate; acrylate and acrylamide; vinylpyrrolidone, vinyl acetate, and vinyl propionate; vinyl caprolactam, vinylpyrrolidoe, and dimethyl aminoethyl methacrylate; and vinylmethylether and maleic anhydride, (lower)alkyl ester.

The hair spray can also contain neutralizers, plasticizers, gloss additives, softening additives, fragrances, protein hydrolysates, vitamins, UV filters, . . . .

Naturally, the invention is not limited to the embodiment described above.

In particular, it is possible to change the number of channels, and the shape and dimensions of the swirling chamber, and of the outlet orifice.

1. A swirling effect nozzle having substance feed channels opening out into a swirling chamber communicating with an outlet orifice, wherein the ratio Aₚ/Aₒ is less than or equal to 0.5 and the ratio Aₚ/(Dₛ·dₒ) is less than or equal to 0.2;
where:
Aₚ is the smallest total section offered by the channels to the passage of the substance;
Aₒ is the section of the outlet orifice;
dₒ is the diameter of the outlet orifice; and
Dₛ is the diameter of the swirling chamber.

2. A nozzle according to claim 1, wherein the ratio Lₛ/Dₛ is less than or equal to 0.25;
where:
Lₛ is the length of the portion of the swirling chamber parallel to the axis of the nozzle and measured along the axis of the nozzle.

3. A nozzle according to claim 1, having a plurality of channels, preferably two to six channels, and more preferably still four channels.

4. A nozzle according to claim 1, wherein the ratio Aₚ/Aₒ is less than or equal to 0.4, advantageously less than or equal to 0.3, preferably lies in the range 0.15 to 0.35, and more preferably lies in the range 0.2 to 0.3.

5. A nozzle according to claim 1, wherein the ratio Aₚ/(Dₛ·dₒ) is less than or equal to 0.15, preferably lies in the range 0.1 to 0.15, and more preferably lies in the range 0.11 to 0.14.

6. A nozzle according to claim 1, wherein the ratio Lₛ/Dₛ is less than or equal to 0.2, is preferably less than or equal to 0.15, and more preferably lies in the range 0.1 to 0.15.

7. A nozzle according to claim 1, wherein the outlet orifice is circularly cylindrical and connects to the swirling chamber via a tapering chamber that converges towards the outlet.

8. A nozzle according to claim 1, wherein dₒ lies in the range 0.4 mm to 1.2 mm, and preferably in the range 0.6 mm to 0.8 mm;
where:
dₒ is the diameter of the outlet orifice.

9. A nozzle according to claim 1, wherein Lₛ lies in the range 0.1 mm to 0.2 mm;
where:
Lₛ is the length of the portion of the swirling chamber parallel to the axis of the nozzle as measured along said axis.

10. A nozzle according to claim 1, wherein Dₛ lies in the range 0.6 mm to 1.4 mm, preferably in the range 0.8 mm to 1.2 mm, and is more preferably close to 1 mm;
where:
Dₛ is the diameter of the swirling chamber.

11. A dispenser head, including a nozzle as defined in claim 1.

12. A head according to claim 11, wherein the nozzle is engaged on a center post.

13. An aerosol receptacle, including a nozzle as defined in claim 1.

14. A receptacle according to claim 13, containing a liquefied propellant gas.

15. A receptacle according to claim 13, containing a propellant gas constituted by a non-liquefied compressed gas, preferably compressed air.

16. A receptacle according to claim 14, containing a cosmetic.

17. A receptacle according to claim 16, wherein said cosmetic is a hair spray.

18. A receptacle according to claim 16, wherein the cosmetic is a deodorant.

19. A receptacle according to claim 14, wherein the mean droplet size of the spray, when the receptacle is full and at 20° C., lies in the range 30 μm to 100 μm, preferably lies in the range 40 μm to 80 μm, and more preferably still is close to 60 μm.

20. A receptacle according to claim 14, wherein the flow rate, when the receptacle is full and at 20° C., lies in the range 0.3 g/s to 1.5 g/s, and preferably lies in the range 0.4 g/s to 1 g/s.

21. A receptacle according to claim 14, wherein the puff force, measured at 20° C. and when the receptacle is full, is less than or equal to 0.05 N, and is preferably close to 0.025 N.

22. A receptacle according to claim 14, wherein the pressure inside the receptacle, when it is full and at 20° C., lies in the range 2 bars to 6 bars.
